(19) United States
(12) Patent Application Publication
(10) Pub. No.: US 2023/0089647 A1
(43) Pub. Date: Mar. 23, 2023

(54) MEASUREMENT APPARATUS UNIT

(71) Applicant: DENSO CORPORATION, Kariya-city (JP)

(72) Inventors: Hiroshi NAKATSUKA, Kariya-city (JP); Riyoko MIYAHARA, Kariya-city (JP)

(21) Appl. No.: 18/058,394

(22) Filed: Nov. 23, 2022

Related U.S. Application Data
(63) Continuation of application No. PCT/JP2021/017260, filed on Apr. 30, 2021.

(30) Foreign Application Priority Data
May 25, 2020 (JP) 2020-090322

(51) Int. Cl. B60R 21/01; G01D 9/02

(52) U.S. Cl. CPC B60R 21/01; G01D 9/02; B60R 2021/01013

(57) ABSTRACT

A measurement apparatus unit is mountable to a vehicle. The measurement apparatus unit includes a first sensor, a first storage apparatus, and a first relay. The first sensor is arranged in a first area among a plurality of areas that are segmented in advance in the vehicle. The first storage apparatus stores therein detection data that is acquired from the first sensor. The first storage apparatus is arranged in a second area that differs from the first area among the plurality of areas. The first relay communicably connects at least the first sensor and the first storage apparatus. The first area and the second area are separated from each other in a traveling direction of the vehicle.

### CROSS-REFERENCE TO RELATED APPLICATION

The present application is a continuation application of International Application No. PCT/JP2021/017260, filed on Apr. 30, 2021, which claims priority to Japanese Patent Application No. 2020-090322, filed on May 25, 2020. The contents of these applications are incorporated herein by reference in their entirety.

### BACKGROUND

### Technical Field

The present disclosure relates to a measurement apparatus unit.

### Related Art

A technology for preventing all recorded data related to a vehicle from being lost when a vehicle accident occurs is known. In this technology, a plurality of electronic control units are each provided with a storage apparatus in order for the plurality of electronic control units to have a drive recorder function, and thus measurement data related to a vehicle is stored in a dispersed manner.

### SUMMARY

One aspect of the present disclosure provides a measurement apparatus unit is mountable to a vehicle. The measurement apparatus unit includes a first sensor, a first storage apparatus, and a first relay. The first sensor is arranged in a first area among a plurality of areas that are segmented in advance in the vehicle. The first storage apparatus stores therein detection data. The first storage apparatus is arranged in a second area that differs from the first area among the plurality of areas. The first relay communicably connects at least the first sensor and the first storage apparatus. The first area and the second area are separated from each other in a traveling direction of the vehicle.

### BRIEF DESCRIPTION OF THE DRAWINGS

In the accompanying drawings:

FIG. 1 is an explanatory diagram illustrating a configuration of a measurement apparatus unit according to a first embodiment;

FIG. 2 is an explanatory diagram illustrating a configuration of a measurement apparatus unit according to a second embodiment;

FIG. 3 is a block diagram schematically illustrating functions of a first splitter;

FIG. 4 is a flowchart illustrating a method for abnormality determination by an abnormality determining unit;

FIG. 5 is an explanatory diagram illustrating a measurement apparatus unit according to a third embodiment;

FIG. 6 is an explanatory diagram illustrating a configuration of a measurement apparatus unit according to a fourth embodiment;

FIG. 7 is an explanatory diagram illustrating a configuration of a measurement apparatus unit according to a fifth embodiment; and

FIG. 8 is an explanatory diagram illustrating a configuration of a measurement apparatus unit according to a sixth embodiment.

### DESCRIPTION OF THE EMBODIMENTS

A technology for prevent all recorded data from being lost when an accident occurs is known (for example, JP-A-2007-163218). In this technology, a plurality of electronic control units are each provided with a storage apparatus in order for the plurality of electronic control units to have a drive recorder function, and thus measurement data related to a vehicle is stored in a dispersed manner.

In the above-described technology, when the plurality of storage apparatuses are near each other, all of the storage apparatuses may become damaged due to an accident. To prevent loss of measurement data, there is a demand for the storage apparatuses to be appropriately arranged inside the vehicle.

It is thus desired to solve at least a portion of the above-described issues. The present disclosure is capable of being implemented as an embodiment or an application example below.

An exemplary embodiment of the present disclosure provides a measurement apparatus unit that is mountable to a vehicle. The measurement apparatus unit includes: a first sensor that is arranged in a first area among a plurality of areas that are segmented in advance in the vehicle; a first storage apparatus that stores therein detection data that is acquired from the first sensor, the first storage apparatus being arranged in a second area that differs from the first area among the plurality of areas; and a first relay that communicably connects at least the first sensor and the first storage apparatus. The first area and the second area are separated from each other in a traveling direction of the vehicle.

According to the measurement apparatus unit of the exemplary embodiment, the first sensor is arranged in the first area among the plurality of areas that are segmented in advance in the vehicle, and the first storage apparatus is arranged in the second area that differs from the first area. Even when the first sensor in the first area fails due to a factor that is attributed to the vehicle, such as a collision accident, a likelihood of the first storage apparatus failing can be reduced. Detection data from the first sensor can be prevented or suppressed from being lost. The first relay is provided between the first sensor and the first storage apparatus. Thus, quality of the detection data from the first sensor can be prevented or suppressed from being decreased. Consequently, data of a large data volume can be outputted from the first sensor and stored in the first storage apparatus that is separated from the first sensor.

In addition, the first area and the second area are separated from each other in a traveling direction of the vehicle. According to this configuration, arrangement positions of the first sensor and the first storage apparatus can be dispersed along the vehicle traveling direction. As a result, both of the first sensor and the first storage apparatus can be reduced from being failed due to impact of a collision accident during traveling of the vehicle.

The above-described exemplary embodiment of the present disclosure will be further clarified through the detailed description below, with reference to the accompanying drawings.

### A. First Embodiment

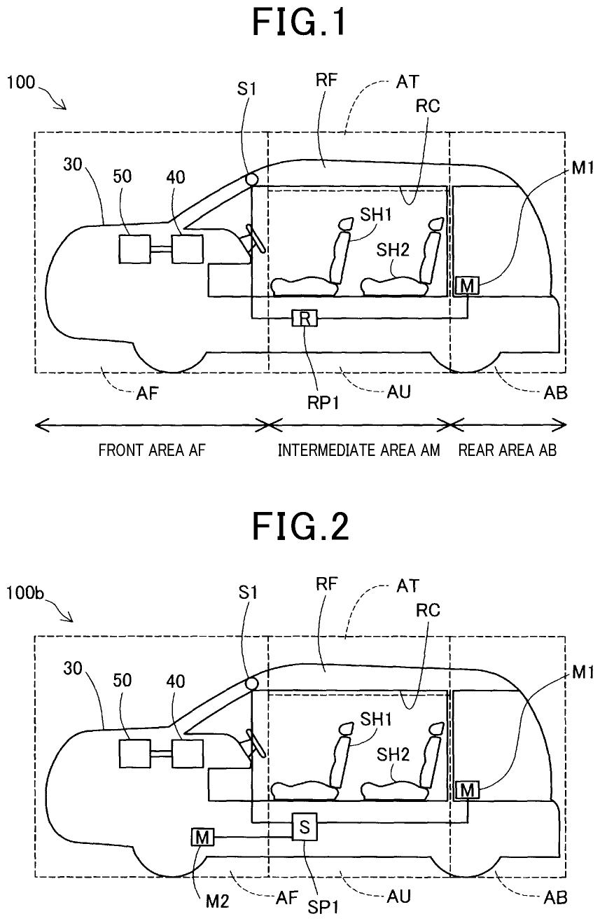

As shown in FIG. 1, a measurement apparatus unit 100 of a first embodiment is mountable to a vehicle 30. The measurement apparatus unit 100 includes a first sensor S1, a first storage apparatus M1, a first repeater RP1, and a data processing apparatus 40. According to the present embodiment, the vehicle 30 is an autonomous driving vehicle that is driven by a human and includes a driving assistance control apparatus 50. For example, the vehicle 30 may be an autonomous driving vehicle that is used for transport of people and cargo, distribution, sales of goods, and the like. The vehicle 30 may also be an autonomous driving vehicle of which driving by a human is not a premise.

In addition to the autonomous driving vehicle, the vehicle 30 may be various motor vehicles that have at least a single motor. In addition to a passenger car, a truck, a bus, and a special vehicle, the vehicle 30 may be a vehicle that is connected to an overhead line, such as a trolley bus, or a vehicle that includes a plurality of car bodies that are connected to each other, such as an articulated bus. In each drawing including FIG. 1, to facilitate understanding of the technology, a storage apparatus is denoted by “M” and a relay that serves as a repeater is denoted by “R.”

The first sensor S1 is a detector such as a camera that acquires image data of a target, Light Detection and Ranging (LiDAR) that acquires a distance to the target and the like, or a millimeter-wave radar that acquires the distance to the target and the like. More specifically, the camera is an imaging apparatus that includes an image sensor, such as a charge-coupled device (CCD), or an image sensor array. The camera is a sensor that outputs, as detection data, image data that includes outer shape information or shape information of the target by receiving visible light. The LiDAR is a sensor that emits infrared laser light, receives reflected light that is reflected by the target, and outputs, as detection data, a distance, a relative speed, and an angle of the target in relation to the vehicle 30. The millimeter-wave radar is a sensor that emits a millimeter wave, receives a reflected wave that is reflected by the target, and outputs, as detection data, the distance, the relative speed, and the angle of the target in relation to the vehicle 30. The first sensor S1 may include other sensors that use electromagnetic waves or light, and the like. The measurement apparatus unit 100 may include a plurality of sensors. In this case, the measurement apparatus unit 100 may include a plurality of sensors of a single type or sensors of a plurality of types.

The detection data from the first sensor S1 is outputted to the first repeater RP1 and the data processing apparatus 40 as a digital signal. For example, the first sensor S1 may output raw data, such as light reception strength of the reflected light acquired from the LiDAR or a captured image of the camera, as the detection data. The first sensor S1 may perform a process on the raw data to extract only information that is required for vehicle control, such as a detection point array or an image of the target, and output the data after processing as the detection data. The first sensor S1 may also output an analog signal.

The data processing apparatus 40 is a microcomputer that includes a logic circuit that is programmed in advance. The data processing apparatus 40 acquires the detection data from the first sensor S1 through wiring (not shown) and generates integrated data using the acquired detection data. The data processing apparatus 40 outputs the generated integrated data to the driving assistance control apparatus 50. The driving assistance control apparatus 50 is a so-called engine control unit (ECU) that is mountable to the vehicle 30. The driving assistance control apparatus 50 performs driving assistance of the vehicle 30 using information that is related to a target in the vicinity of the vehicle 30 that is inputted from the data processing apparatus 40. For example, driving assistance of the vehicle 30 may include brake assistance, steering assistance, drive assistance, and the like that are performed using the information related to the target in the vicinity of the vehicle 30 that is inputted from the measurement apparatus unit 100.

The first repeater RP 1 is a relay for telecommunications and is an aspect of a “first relay” that is recited in the scope of claims. The first repeater RP1 functions as a so-called digital repeater. The first repeater RP1 performs a process to amplify, reshape, and retime a digital input signal that serves as the detection data that is received from the first sensor Si (also referred to, hereafter, as a “signal shaping process”) and outputs the signal to the first storage apparatus M1. The signal shaping process can prevent or suppress attenuation, distortion in signal waveform, occurrence of jittering, and the like of the electrical signal during data transmission from the first sensor S1 to the first storage apparatus M1. The signal that is handled by the first repeater RP1 may be an optical signal or a wireless signal, in addition the electrical signal in wired communication. The first repeater RP1 may be an analog repeater that amplifies the input signal in an analog manner.

The first storage apparatus M1 is a non-volatile auxiliary storage apparatus. According to the present embodiment, the first storage apparatus M1 includes a hard disk drive that is configured to be capable of being freely read and written. The first storage apparatus M1 stores therein the detection data that is outputted from the first sensor S1. The first storage apparatus M1 may include various recording media, such as a NAND-type or NOR-type flash memory, a magnetic disk, an optical disc, a magneto-optical disc, and the like. The detection data that is stored in the first storage apparatus M1 may be accessible in a wired or wireless manner from an external apparatus of the vehicle 30.

The first sensor S1, the first repeater RP1, and the first storage apparatus M1 are in wired connection by wiring. For example, a communication protocol, such as Ethernet (registered trademark), Flat Panel Display Link (FPD-LINK), Gigabit Video Interface (GVIF), low voltage differential signaling (LVDS), e.g., Gigabit Multimedia Serial Link (GMSL), or HDBase-T, may be used for communication between the first sensor S1, the first repeater RP1, and the first storage apparatus M1.

Arrangement of the first sensor S1, the first storage apparatus M1, and the first repeater RP1 in the vehicle 30 will be described with reference to FIG. 1. As shown in FIG. 1, the first sensor S1, the first storage apparatus 1, and the first repeater RP1 are arranged such as to be dispersed among a plurality of areas that are segmented in advance in the vehicle 30. The “plurality of areas of the vehicle 30” refers to spaces that are obtained by a space that is occupied by the vehicle 30 and a unit that is mounted outside the vehicle 30 being segmented into a plurality of spaces. The plurality of areas of the vehicle 30 are preferably segmented such that risk of failure of the apparatuses that are arranged in the areas differs from one another, to be capable of suppressing or preventing failure of all apparatuses that are arranged in the vehicle 30 due to a factor attributed to the vehicle 30.

For example, “a factor attributed to the vehicle 30” refers to impact to the vehicle 30 due to a collision with another vehicle or an object other than the vehicle 30 during traveling of the vehicle 30, changes in temperature in each area due to outside air or sunlight, and the like. The plurality of areas of the vehicle 30 are more preferably segmented based on an area that may be affected by impact that is generated in the vehicle 30 due to a collision with the vehicle 30 by another vehicle, a collision with the vehicle 30 by an object other than the vehicle 30 or another vehicle, such as a falling rock, a collision with the vehicle 30 based on various factors during traveling of the vehicle 30, such as wheel detachment and falling, and the like, in addition to a factor attributed to the vehicle 30.

For example, when a collision accident occurs in one area of the vehicle 30, a sensor that is arranged in the area that includes a site of impact may have a higher likelihood of detecting data that is related to the collision accident, but also have a higher likelihood of failing due to the impact of the collision accident. Therefore, to prevent data related to the collision accident from becoming lost, the sensor and the storage apparatus that stores the detection data from the sensor are preferably arranged in areas that differ from each other. The areas are more preferably separated from each other (disposed separately from each other or spaced apart from each other). The plurality of areas of the vehicle 30 are preferably set for each vehicle type based on a structure, shape, safety performance, and the like of the vehicle 30. The plurality of areas of the vehicle 30 may also be set based on a traveling direction of the vehicle 30, an environment in which the vehicle 30 is used, and the like. The plurality of areas of the vehicle 30 are segmented into four areas to which the risk of failure of the apparatuses in the areas due to a collision accident is distributed. More specifically, the plurality of areas of the vehicle 30 are segmented into a front area AF that includes a front of the vehicle 30 along the traveling direction of the vehicle 30, a rear area

AB that includes a rear of the vehicle 30, and an intermediate area AM that is positioned between the front area AF and the rear area AB. The intermediate area AM is further segmented into an upper area AT that includes a ceiling RC and a roof RF of the vehicle 30, and a lower area AU that includes a vehicle cabin and below the vehicle cabin of the vehicle 30.

For example, when the vehicle 30 is a compact vehicle or the risk of failure of the apparatuses is not distributed among the four areas for structural reasons of the vehicle 30, the plurality of areas of the vehicle 30 may be segmented into only the front area AF and the rear area AB, without including the intermediate area AM. In addition to being segmented into front and rear, and up and down along the traveling direction of the vehicle 30, the plurality of areas of the vehicle 30 may be further segmented in a width direction of the vehicle 30, such as segmented into side areas that include a left-side surface and a right-side surface of the vehicle 30. The plurality of areas of the vehicle 30 is not limited to the four areas, and may be five or more areas, or may be segmented into an arbitrary number of areas that is two or more.

For example, when the vehicle 30 has a shape that is elongated along the traveling direction, the intermediate area AM may be further segmented into a plurality of areas along the traveling direction. When the vehicle 30 is long in an up/down direction, the intermediate area AM may be further segmented into a plurality of areas along a vertical direction, between the upper area AT and the lower area AU. The front area AF and the rear area AB may each be segmented into a plurality of areas along the vertical direction. When the vehicle 30 has a plurality of levels in the vertical direction, the plurality of areas may be segmented by each level. The plurality of areas of the vehicle 30 is not limited to segmentation by space and, for example, may be segmented by each component that configures the vehicle 30, such as a door or a bumper.

According to the present embodiment, the front area AF of the vehicle 30 is an area that is further towards a front side in the traveling direction of the vehicle than a seat SH1 in a first row inside the vehicle cabin is. For example, the front area AF of the vehicle 30 may include a front compartment such as a glove box, a console box, and an instrument panel, a front bumper, an engine room, and the like of the vehicle 30. Compared to other areas, for example, the front area AF of the vehicle 30 may receive greater impact from a collision accident to the front of the vehicle 30 and less impact from a collision accident with another vehicle to the rear of the vehicle 30. The front area AF of the vehicle 30 may include an area of the roof RF of the vehicle 30 that is further towards the front side in the traveling direction of the vehicle than the seat SH1 in the first row inside the vehicle cabin is. The front area AF may be set using a distance from a front end of the vehicle 30. In this case, the distance from the front end of the vehicle 30 is preferably determined based on the area that is affected by impact from a collision accident to the front of the vehicle 30. According to the present embodiment, the first sensor S1 is arranged in the front area AF. The area in which the first sensor S1 is arranged is referred to, hereafter, as a “first area.”

According to the present embodiment, the lower area AU of the vehicle 30 is an area that includes the vehicle cabin inside the vehicle 30 that includes from the seat SH1 in the first row to a backseat SH2, and below the seats. The lower area AU may include, in addition to the seat SH1 and the backseat SH2, a center arm rest of the seat SH1 of the vehicle 30 and the like. When the seats are provided in two or more rows, the lower area AU may include from the seat SH1 in the first row to the seat in a last row, and may include an area below the seats up to the seat in the last row. When the vehicle 30 does not include seats, an area that excludes the front area AF and the rear area AB, and includes the vehicle cabin and below the vehicle cabin may be the lower area AU. According to the present embodiment, the first repeater RP1 is arranged in the lower area AU of the vehicle 30.

According to the present embodiment, the upper area AT of the vehicle 30 is an area that includes the ceiling RC of the vehicle cabin, an interior of the roof RF of the vehicle 30, and an upper portion of the roof RF of the vehicle 30. For example, a structure that is separate from the vehicle 30 that is mountable to the upper portion of the roof RF, such as a roof box or a sensor unit in which a sensor is mounted, may be included in the upper portion of the roof RF of the vehicle 30.

According to the present embodiment, the rear area AB of the vehicle 30 is an area that is further towards the rear side than the backseat SH2 is. For example, the rear area AB of the vehicle 30 may include a rear compartment such as a trunk, a boot, or a luggage space of the vehicle 30. The rear area AB may be set using a distance from a rear end of the vehicle 30. In this case, the distance from the rear end of the vehicle 30 is preferably determined based on the area that is affected by impact from a collision accident to the rear of the vehicle 30 or a collision accident to the rear of the vehicle 30 by another vehicle. According to the present embodiment, the first storage apparatus M1 is arranged inside the trunk of the vehicle 30 that serves as the rear area AB of the vehicle 30. The area in which the first storage apparatus M1 is arranged is referred to, hereafter, as a “second area.”

As described above, according to the measurement apparatus unit 100 of the present embodiment, the first sensor S1 is arranged in the front area AF and the first storage apparatus M1 is arranged in the rear area AB. The first sensor S1 and the first storage apparatus M1 are arranged in areas that differ from each other. Thus, even when a collision accident occurs in the front area AF in which the first sensor S1 is arranged, a likelihood of the first storage apparatus M1 failing can be reduced. Detection data that detects a state of the collision accident can be prevented or suppressed from being lost. The first repeater RP1 that serves as a relay is provided between the first sensor S1 and the first storage apparatus M1. Thus, quality of the detection data from the first sensor S1 can be prevented from being decreased through the signal rectification process by the first repeater RP 1. Therefore, data of a large data volume can be outputted from the first sensor S1 and stored in the first storage apparatus M1 that is separated from the first sensor S1.

According to the measurement apparatus unit 100 of the present embodiment, the plurality of areas of the vehicle 30 are segmented into the front area AF that includes the front of the vehicle 30 and the rear area AB that includes the rear of the vehicle 30. The arrangement of the first sensor S1 and the first storage apparatus M1 are dispersed along the vehicle traveling direction. Thus, the risk of failure of the apparatuses due to impact of a collision accident during traveling of the vehicle 30 can be distributed.

According to the measurement apparatus unit 100 of the present embodiment, the plurality of areas of the vehicle 30 further includes the intermediate area AM between the front area AF and the rear area AB. The intermediate area AM is further segmented into the upper area AT and the lower area AU. The plurality of areas are appropriately segmented based on the structure of the vehicle 30. Thus, the risk of failure of the apparatuses that are arranged in the vehicle can be appropriately distributed.

### B. Second Embodiment

As shown in FIG. 2, a measurement apparatus unit 100b of a second embodiment differs from the measurement apparatus unit 100 of the first embodiment in that a second storage apparatus M2 is further included and a first splitter SP1 that serves as a first relay is included instead of the first repeater RP1. The measurement apparatus unit 100b is similar to the measurement apparatus unit 100 of the first embodiment in other regards. In each drawing including FIG. 2, to facilitate understanding of the technology, a relay that serves as a splitter is denoted by “S.”

The second storage apparatus M2 is a non-volatile auxiliary storage apparatus. A storage apparatus that is identical to the first storage apparatus M1 may be used as the second storage apparatus M2. Alternatively, a storage apparatus that has data capacity that differs from that of the first storage apparatus M1 may be used as the second storage apparatus M2. According to the present embodiment, the second storage apparatus M2 is housed in the front compartment of the vehicle 30 and is arranged in the front area AF among the plurality of areas of the vehicle 30. The area in which the second storage apparatus M2 is arranged is also referred to, hereafter, as a “third area.” The second storage apparatus M2 is preferably arranged in an area that differs from the second area in which the first storage apparatus M1 is arranged, to distribute risk of loss of the detection data.

The first splitter SP1 is a so-called distributor that distributes a digital input signal to a plurality of apparatuses. The first splitter SP1 outputs the detection data from the first sensor S1 to the first storage apparatus M1 and the second storage apparatus M2. According to the present embodiment, in a manner similar to the first repeater RP1, the first splitter SP1 performs a signal shaping process in which the digital input signal is amplified, reshaped, and retimed. The first splitter SP1 may reshape and distribute an analog signal, in addition to the digital input signal.

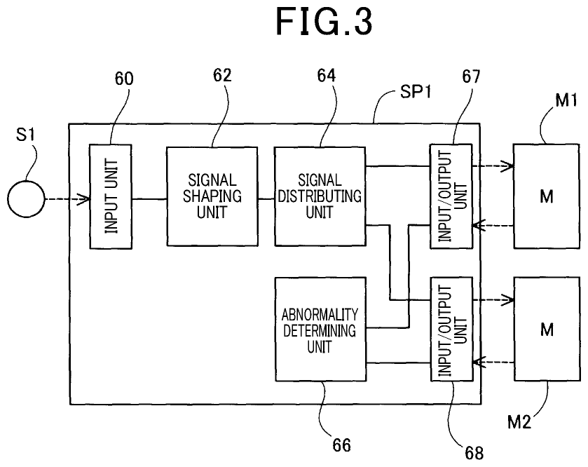

A specific configuration of the first splitter SP1 will be described with reference to FIG. 3. As shown in FIG. 3, the first splitter SP1 includes an input unit 60, a signal shaping unit 62, a signal distributing unit 64, an abnormality determining unit 66, a first input/output unit 67, and a second input/output unit 68. The first splitter SP1 may be configured by hardware by an integrated circuit, such as a field-programmable gate array (FPGA) or an application-specific integrated circuit (ASIC), that is programmed in advance. The first sensor S1 is connected to the input unit 60 by a detection signal line that serves as wiring. The detection data is inputted from the first sensor S1. The first storage apparatus M1 is connected to the first input/output unit 67 by a data signal line, and the second storage apparatus M2 is connected to the second input/output unit 68 by a data signal line. The input/output unit is not limited to two, and an arbitrary number, such as three or more, may be provided.

The signal shaping unit 62 performs the signal shaping process on the digital input signal that serves as the detection data that is received from the first sensor S1, and outputs the signal to the signal distributing unit 64. The signal distributing unit 64 distributes the detection data on which the signal shaping process is performed to the first input/output unit 67 and the second input/output unit 68, and outputs the detection data to the first storage apparatus M1 and the second storage apparatus M2. According to the present embodiment, the signal distributing unit 64 redundantly stores raw data that serve as the detection data from the first sensor S1 in both the first storage apparatus M1 and the second storage apparatus M2. Redundant storage in the storage apparatuses M1 and M2 includes when the sets of detection data are essentially identical to each other, in addition to when the sets of detection data are stored so as to completely match each other.

For example, when the first sensor S1 is a camera, the signal distributing unit 64 may output a camera captured image that is raw data to the first storage apparatus M1 and output image data in which a frame rate is decreased to the second storage apparatus M2. In such a manner, the detection data from the sensor may be such that data volume that is outputted to one storage apparatus and data volume that is outputted to another storage differ. According to this configuration of the measurement apparatus unit 100b, the capacity of one storage apparatus may be decreased in relation to that of the other storage apparatus. The signal distributing unit 64 may switch the storage apparatus that is an output destination of the detection data for each period that is prescribed in advance, or may process the detection data from the sensor and output the detection data as differing sets of detection data to the storage apparatuses M1 and M2.

For example, a distribution method of the detection data to the storage apparatuses by the signal distributing unit 64 may be controlled by a control apparatus that is separate from the measurement apparatus unit 100b, such as the driving assistance control apparatus 50. The abnormality determining unit 66 reads the identical sets of detection data that are stored in the first storage apparatus M1 and the second storage apparatus M2, and determines whether the sets of detection data match each other by comparing the sets of detection data with each other.

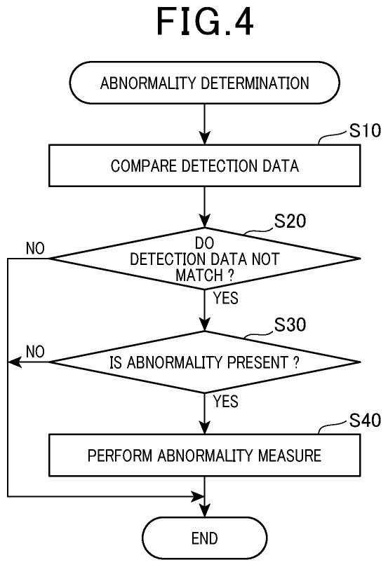

An abnormality determination method for the detection data performed by the abnormality determining unit 66 will be described with reference to FIG. 4. For example, a process shown in FIG. 4 may be repeatedly performed such as for each period of several milliseconds that is prescribed in advance, from when a start switch of the vehicle 30 is turned on until the start switch is turned off.

The abnormality determining unit 66 reads the sets of detection data from the first storage apparatus M1 and the second storage apparatus M2, and compares the sets of detection data with each other (step S10). The abnormality determining unit 66 determines whether the sets of detection data match each other (step S20). For example, when the first sensor S1 is a camera, the abnormality determining unit 66 may determine whether the sets of image data match each other for each frame that is acquired per unit time, as the comparison of image data. For example, as a case in which the sets of detection data do not match each other, a case in which, in relation a set of image data that is stored in one storage apparatus of the storage apparatuses M1 and M2, pixel data of the other set of image data is less is given. To accurately perform comparison of the detection data, for example, the first storage apparatus M1 and the second storage apparatus M2 are preferably synchronized with each other through use of a time server or a clock signal.

Upon determining that the sets of detection data that are stored in the storage apparatuses M1 and M2 match each other (NO at S20), the abnormality determining unit 66 ends the process. According to the present embodiment, when the sets of detection data do not match each other (YES at S20), the abnormality determining unit 66 determines whether or an abnormality is present in the detection data (S30). As a case in which an abnormality is present in the detection data, a case in which the image data is not stored in either of the storage apparatuses and the like can be given. An abnormality may be determined to be present due to an amount of data of a set detection data being less than that of the other set of detection data. To improve accuracy of the comparison of detection data, the sets of detection data may be compared so as to include changes over time thereof In addition to comparison of detection data, presence/absence of an abnormality may be determined by comparison that includes detection data from other sensors.

When determined that an abnormality is present in the detection data, the abnormality determining unit 66 performs an abnormality measure (step S40). For example, the abnormality measure may include, in addition to a process in which the set of detection data that is determined to have an abnormality is repaired, changing a storage destination of the detection data, and notifying a user or a manager of the vehicle 30 that an abnormality is present. According to the present embodiment, as a process for repairing the detection data, the abnormality determining unit 66 repairs the set of detection data that is determined to have an abnormality using the other set of detection data.

For example, the set of detection data that is stored in one storage apparatus that is determined to have an abnormality may be overwritten by the set of detection data that is stored in the other storage apparatus. In addition to the abnormality measure, the abnormality determining unit 66 may notify the user or the manager of the vehicle 30 of the presence/absence of an abnormality using display by a display apparatus that is provided in the vehicle 30 or sound. The abnormality determining unit 66 may omit step S30 and perform the abnormality measure of notifying that the sets of detection data do not match when the sets of detection data do not match at step S20. The abnormality determining unit 66 completes the process when the abnormality measure is ended.

According to the measurement apparatus unit 100b of the present embodiment, the first splitter SP1 that distributes the detection data that is inputted from the first sensor S1 to the first storage apparatus M1 and the second storage apparatus M2 is included. The detection data from the first sensor S1 is distributed to a plurality of storage apparatuses, and the storage destinations of the detection data are dispersed. As a result, all detection data can be prevented or suppressed from being lost. The first storage apparatus M1 and the second storage apparatus M2 are arranged in differing areas that are separated from each other. Thus, all detection data can be prevented or reliably suppressed from being lost.

According to the measurement apparatus unit 100b of the present embodiment, the abnormality determining unit 66 redundantly stores the detection data from the first sensor Si in the storage apparatuses M1 and M2, and determines whether the sets of detection data match each other. Therefore, an abnormality in the detection data can be detected at an early stage. The abnormality determining unit 66 repairs the set of detection data that is determined to have an abnormality using the other set of detection data. Therefore, the detection data can be reduced from being lost due to the storage apparatus and data communication.

### C. Third Embodiment

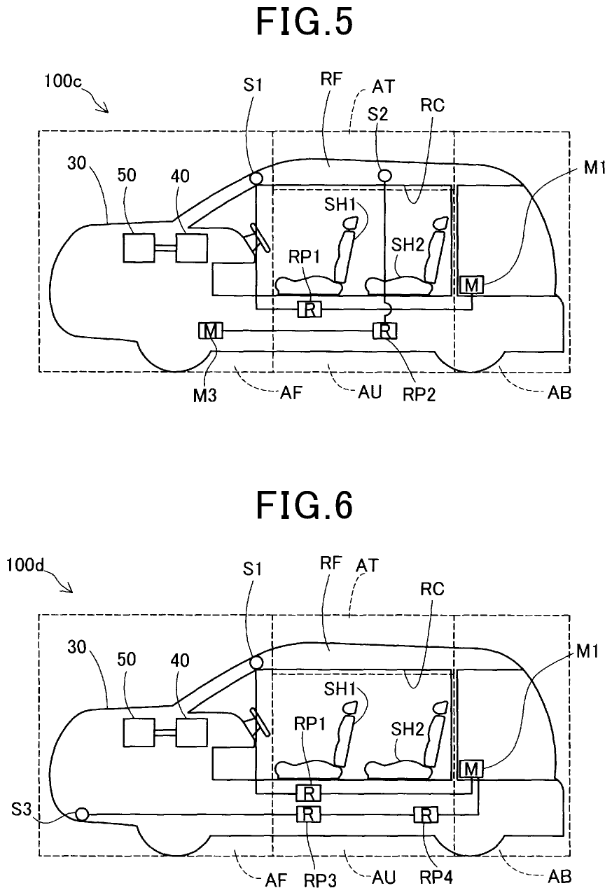

As shown in FIG. 5, a measurement apparatus unit 100c of a third embodiment differs from the measurement apparatus unit 100 of the first embodiment in that a second sensor S2, a second repeater RP 1, and a third storage apparatus M3 are further included. The measurement apparatus unit 100c is similar to the measurement apparatus unit 100 of the first embodiment in other regards.

In a manner similar to the first sensor S1, the second sensor S2 is a detector such as a camera, a LiDAR, or a millimeter-wave radar. The second sensor S2 may be detector of a type that differs from the first sensor S1. The second sensor S2 is arranged in the upper area AT. The second sensor S2 is not limited to an area that differs from the first sensor S1 and may be arranged in the same area as the first sensor S1. The area in which the second sensor S2 is arranged is also referred to hereafter, as a “fourth area.”

In a manner similar to the first storage apparatus M1, the third storage apparatus M3 is a non-volatile auxiliary storage apparatus. The third storage apparatus M3 stores therein detection data from the second sensor S2. The third storage apparatus M3 is arranged in an area that differs from the upper area AT in which the second sensor S2 is arranged. More specifically, the third storage apparatus M3 is housed in the front compartment of the vehicle 30 and arranged in the front area AF. An arrangement position of the third storage apparatus M3 is more preferably farther away from the second sensor S2. The third storage apparatus M3 may be arranged in the same area as the first storage apparatus M1. The area in which the third storage apparatus M3 is arranged is also referred to, hereafter, as a “fifth area.”

The second repeater RP2 is a digital repeater that is configured in a manner similar to the first repeater RP1, and is arranged between the second sensor S2 and the third storage apparatus M3. The second repeater RP2 is an aspect of a “second relay” that is recited in the scope of claims. According to the present embodiment, the second repeater RP2 is housed below the backseat SH2 and is arranged in the lower area AU. The second repeater RP2 performs the signal shaping process on the detection data from the second sensor S2 and outputs the detection data to the third storage apparatus M3.

According to the measurement apparatus unit 100c of the present embodiment, the plurality of sensors S1 and S2 and the plurality of storage apparatuses M1 and M3 that store therein the detection data from the sensors are provided. The detection data from the plurality of sensors are stored in differing storage apparatuses M1 and M3. Thus, even when one sensor or storage apparatus fails, supplementation by the other sensor or storage apparatus can be performed. Thus, the detection data can be further reduced from being lost. In addition, the detection data from the plurality of sensors are individually stored in the storage apparatuses M1 and M2. Thus, the sets of detection data stored in the storage apparatuses M1 and M3 are compared to each other. As a result, the presence/absence of an abnormality in the detection data can be determined.

### D. Fourth Embodiment

As shown in FIG. 6, a measurement apparatus unit 100d of a fourth embodiment differs from the measurement apparatus unit 100 of the first embodiment in that a third sensor S3, a third repeater RP3, and a fourth repeater RP4 are further included. The measurement apparatus unit 100d is similar to the measurement apparatus unit 100 of the first embodiment in other regards.

In a manner similar to the first sensor S1, the third sensor S3 is a detector such as a camera, a LiDAR, or a millimeter-wave radar. The third sensor S3 may be detector of a type that differs from the first sensor S1. The third sensor S3 is arranged in the front area AF. The third sensor S3 is not limited to the same area as the first sensor S1 and may be arranged in an area that differs from the first sensor S1. The detection data from the third sensor S3 is stored in the first storage apparatus M1 together with the detection data of the first sensor S1. A length of wiring from the first storage apparatus M1 to the third sensor S3 is greater than a length of wiring from the first storage apparatus M1 to the first sensor S1. According to the present embodiment, two relays that are the third repeater RP3 and the fourth repeater RP4 are included between the third sensor S3 and the first storage apparatus M1.

According to the measurement apparatus unit 100d of the present embodiment, the plurality of relays are provided between the third sensor S3 and the first storage apparatus M1 of which a separation distance is great. Therefore, even when the separation distance is great, quality of the detection data can be prevented or suppressed from being decreased. The separation distance between the third sensor S3 and the first storage apparatus M1 is made great. Thus, the detection data from the third sensor S3 can be reduced from being lost when a collision accident in which the third sensor S3 fails occurs.

According to the measurement apparatus unit 100d of the present embodiment, the detection data from the third sensor S3 is stored in the first storage apparatus M1 together with the detection data of the first sensor S1. A number of sensors and a number of storage apparatuses do not match each other, and the detection data from a plurality of sensors are stored in a single storage apparatus. Thus, the detection data can be centrally managed by the single storage apparatus. As a result, the storage apparatus can be suppressed from being needlessly increased. In addition, increase in arrangement positions of the storage apparatus can be suppressed.

### E. Fifth Embodiment

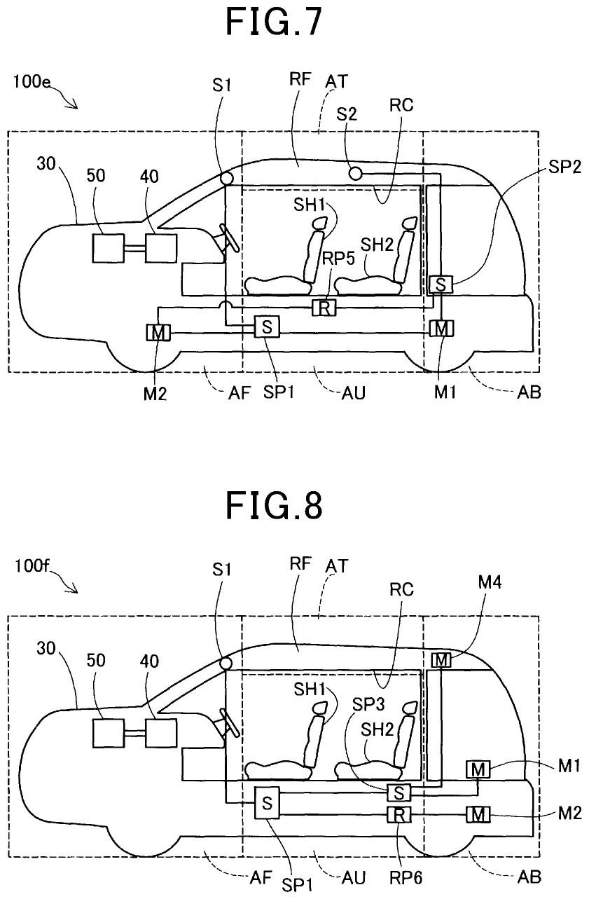

As shown in FIG. 7, in a measurement apparatus unit 100e of a fifth embodiment, in a manner similar to the measurement apparatus unit 100b of the second embodiment, the first sensor S1 is connected to the first storage apparatus M1 and the second storage apparatus M2 with the first splitter SP1 that serves as the first relay therebetween. The measurement apparatus unit 100e of the present embodiment differs from the measurement apparatus unit 100b of the second embodiment in that the second sensor S2, a second splitter SP2, and a fifth repeater RP5 are further included. The measurement apparatus unit 100e is similar to the measurement apparatus unit 100b of the second embodiment in other regards.

The second sensor S2 is a sensor that is arranged in the upper area AT. A configuration of the second sensor S2 is similar to that of the second sensor S2 of the third embodiment. The second sensor S2 is connected in a wired manner to the first storage apparatus M1 in the front area AF and the second storage apparatus M2 in the rear area AB with the second splitter SP2 that is arranged in the rear area AB therebetween. The second splitter SP2 is an aspect of the “second relay” that is recited in the scope of claims. A configuration of the second splitter SP2 is similar to that of the first splitter SP1. The detection data from the second sensor S2 undergoes a signal shaping process by the second splitter SP2, and is stored in the first storage apparatus M1 and the second storage apparatus M2. According to the present embodiment, the first storage apparatus M1 and the second storage apparatus M2 are also referred to as the “third storage apparatus” because the detection data from the second sensor S2 is stored therein.

The fifth repeater RP5 is a digital repeater that is arranged between the second splitter SP2 and the second storage apparatus M2. A configuration of the fifth repeater RP5 is similar to that of the first repeater RP1 of the first embodiment. The fifth repeater RP5 is arranged between the second splitter SP2 and the second storage apparatus M2. Thus, quality of the detection data from the second splitter SP2 can be prevented or suppressed from being decreased. In this manner, relays of a plurality of differing types may be provided between the second sensor S2 and the second storage apparatus M2.

According to the measurement apparatus unit 100e of the present embodiment, the plurality of relays that are configured by the splitters SP1 and SP2 and the fifth repeater RP5 are arranged as appropriate based on a form of the vehicle 30. Thus, quality of the detection data of the first sensor S1 and the second sensor S2 can be prevented or suppressed from being decreased. In addition, the detection data of the first sensor S1 and the second sensor S2 can be redundantly stored in the storage apparatuses M1 and M2 that are separated from each other.

### F. Sixth Embodiment

As shown in FIG. 8, in a measurement apparatus unit 100f of a sixth embodiment, the first sensor S1 is connected to the first storage apparatus M1, the second storage apparatus M2, and a fourth storage apparatus M4 that are arranged in the rear area AB. In the measurement apparatus unit 100f of the present embodiment, a third splitter SP3 is further provided between the first splitter SP1 and the first storage apparatus M1. The third splitter SP3 is connected to the first storage apparatus M1 and the fourth storage apparatus M4. A sixth repeater RP6 is further provided between the first splitter SP1 and the second storage apparatus M2. The detection data from the first sensor S1 is inputted to the first splitter SP1, outputted to the sixth repeater RP6 and the third splitter SP3 by the first splitter SP1, and outputted to the storage apparatuses M1, M2, and M4. The first splitter SP1 may read the sets of detection data in the first storage apparatus M1, the second storage apparatus M2, and the fourth storage apparatus M4, and determine presence/absence of an abnormality in the detection data by comparing the sets of detection data. According to this configuration of the measurement apparatus unit 100f, a set of detection data that does not match two sets of detection data that match each other among the sets of detection data stored in the three storage apparatuses M1, M2, and M3 can be determined to be abnormal. Therefore, accuracy of abnormality detection of the detection data can be improved.

According to the measurement apparatus unit 100f of the present embodiment, the plurality of relays that are configured by the splitters SP1 and SP3 and the sixth repeater RP6 are arranged as appropriate based on the form of the vehicle 30. Thus, quality of the detection data of the first sensor S1 can be prevented or suppressed from being decreased. In addition, the detection data of the first sensor S1 can be redundantly stored in the storage apparatuses M1, M2, and M4 that are separated from the first sensor S1.

### G. Other Embodiments

(G1) According to the above-described second embodiment, the abnormality determining unit 66 is provided in the first splitter SP1 that serves as the first relay. However, for example, the abnormality determining unit 66 may be provided in a component other than the first relay, such as being provided in the data processing apparatus 40 or the driving assistance control apparatus 50.

The control unit and a method thereof described in the present disclosure may be implemented by a dedicated computer that is provided so as to be configured by a processor and a memory, the processor being programmed to provide one or a plurality of functions that are implemented by a computer program. Alternatively, the control unit and a method thereof described in the present disclosure may be implemented by a dedicated computer that is provided by a processor being configured by a single dedicated hardware logic circuit or more.

Still alternatively, the control unit and a method thereof described in the present disclosure may be implemented by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory computer-readable (tangible) storage medium that can be read by a computer as instructions performed by the computer.

The present disclosure is not limited to the above-described embodiments and variation examples, and can be implemented through various configurations without departing from the spirit of the disclosure. For example, technical features of embodiments and variation examples that correspond to technical features in each aspect described in the summary of the invention can be replaced and combined as appropriate to solve some or all of the above-described issued or to achieve some or all of the above-described effects. Furthermore, the technical features may be omitted as appropriate unless described as a requisite in the present specification.

What is claimed is:

1. A measurement apparatus unit that is mountable to a vehicle, the measurement apparatus unit comprising:
a first sensor that is arranged in a first area among a plurality of areas that are segmented in advance in the vehicle;
a first storage apparatus that stores therein detection data that is acquired from the first sensor, the first storage apparatus being arranged in a second area that differs from the first area among the plurality of areas; and
a first relay that communicably connects at least the first sensor and the first storage apparatus, wherein
the first area and the second area are separated from each other in a traveling direction of the vehicle.

2. The measurement apparatus unit according to claim 1, wherein:
the plurality of areas are segmented in advance into a front area that includes a front of the vehicle and a rear area that includes a rear of the vehicle.

3. The measurement apparatus unit according to claim 2, wherein:
the plurality of areas are segmented in advance into an intermediate area that is positioned between the front area and the rear area, and includes an upper area that includes a ceiling of the vehicle and a lower area that includes below the ceiling of the vehicle.

4. The measurement apparatus unit according to claim 3, further comprising:
a second storage apparatus that differs from the first storage apparatus and is arranged in a third area that differs from the second area among the plurality of areas, wherein
the first relay further communicably connects the first sensor and the second storage apparatus, and outputs the detection data that is inputted from the first sensor to the first storage apparatus and the second storage apparatus.

5. The measurement apparatus unit according to claim 4, further comprising:
an abnormality determining unit that redundantly stores the detection data in the first storage apparatus and the second storage apparatus, compares the redundantly stored detection data, and determines whether the redundantly stored detection data match each other.

6. The measurement apparatus unit according to claim 5, further comprising:
a second sensor that is arranged in a fourth area among the plurality of areas;
a third storage apparatus that stores therein detection data that is acquired from the second sensor, and is arranged in a fifth area that differs from the fourth area among the plurality of areas; and
a second relay that communicably connects at least the second sensor and the third storage apparatus, and amplifies or reshapes an inputted electrical signal and outputs the electrical signal.

7. The measurement apparatus unit according to claim 1, further comprising:
a second storage apparatus that differs from the first storage apparatus and is arranged in a third area that differs from the second area among the plurality of areas, wherein
the first relay further communicably connects the first sensor and the second storage apparatus, and outputs the detection data that is inputted from the first sensor to the first storage apparatus and the second storage apparatus.

8. The measurement apparatus unit according to claim 2, further comprising:
a second storage apparatus that differs from the first storage apparatus and is arranged in a third area that differs from the second area among the plurality of areas, wherein the first relay further communicably connects the first sensor and the second storage apparatus, and outputs the detection data that is inputted from the first sensor to the first storage apparatus and the second storage apparatus.

9. The measurement apparatus unit according to claim 7, further comprising:
an abnormality determining unit that redundantly stores the detection data in the first storage apparatus and the second storage apparatus, compares the redundantly stored detection data, and determines whether the redundantly stored detection data match each other.

10. The measurement apparatus unit according to claim 8, further comprising:
an abnormality determining unit that redundantly stores the detection data in the first storage apparatus and the second storage apparatus, compares the redundantly stored detection data, and determines whether the redundantly stored detection data match each other.

11. The measurement apparatus unit according to claim 1, further comprising:
a second sensor that is arranged in a fourth area among the plurality of areas;
a third storage apparatus that stores therein detection data that is acquired from the second sensor, and is arranged in a fifth area that differs from the fourth area among the plurality of areas; and
a second relay that communicably connects at least the second sensor and the third storage apparatus, and amplifies or reshapes an inputted electrical signal and outputs the electrical signal.

12. The measurement apparatus unit according to claim 2, further comprising:
a second sensor that is arranged in a fourth area among the plurality of areas;
a third storage apparatus that stores therein detection data that is acquired from the second sensor, and is arranged in a fifth area that differs from the fourth area among the plurality of areas; and
a second relay that communicably connects at least the second sensor and the third storage apparatus, and amplifies or reshapes an inputted electrical signal and outputs the electrical signal.

13. The measurement apparatus unit according to claim 3, further comprising:
a second sensor that is arranged in a fourth area among the plurality of areas;
a third storage apparatus that stores therein detection data that is acquired from the second sensor, and is arranged in a fifth area that differs from the fourth area among the plurality of areas; and
a second relay that communicably connects at least the second sensor and the third storage apparatus, and amplifies or reshapes an inputted electrical signal and outputs the electrical signal.

14. The measurement apparatus unit according to claim 4, further comprising:
a second sensor that is arranged in a fourth area among the plurality of areas;
a third storage apparatus that stores therein detection data that is acquired from the second sensor, and is arranged in a fifth area that differs from the fourth area among the plurality of areas; and
a second relay that communicably connects at least the second sensor and the third storage apparatus, and amplifies or reshapes an inputted electrical signal and outputs the electrical signal.
